(19) United States
(12) Patent Application Publication
(10) Pub. No.: US 2021/0284088 A1
(43) Pub. Date: Sep. 16, 2021

(54) SYSTEM, IN-VEHICLE DEVICE, AND INFORMATION PROCESSING METHOD FOR CUSTOMIZING VEHICLE EQUIPMENT SETTINGS

(71) Applicant: TOYOTA JIDOSHA KABUSHIKI KAISHA, Toyota-shi (JP)

(72) Inventors: Tomonari YAMAGUCHI, Miyoshi-shi (JP); Masanori KUSHIBE, Toyota-shi (JP)

(73) Assignee: TOYOTA JIDOSHA KABUSHIKI KAISHA, Toyota-shi (JP)

(21) Appl. No.: 17/189,977

(22) Filed: Mar. 2, 2021

(30) Foreign Application Priority Data
Mar. 13, 2020 (JP) 2020-043699

(51) Int. Cl. B60R 16/037; H04W 4/80; H04W 4/40; G06F 21/31; H04W 12/033; B60R 16/023

(52) U.S. Cl. CPC B60R 16/037; H04W 4/80; B60R 16/0231; G06F 21/31; H04W 12/033; H04W 4/40

(57) ABSTRACT

An in-vehicle device receives personalization information including user vehicle settings from one or more user terminals within a predetermined range from the vehicle. The in-vehicle device stores the received personalization information in a storage or memory unit. The in-vehicle device performs an authentication process to identify a specific user on board the vehicle. The in-vehicle device selects the personalization information corresponding to the identified specific user from the personalization information stored in the storage unit. The in-vehicle device transmits the selected personalization information to an equipment controller for controlling equipment settings of the vehicle according to the selected personalization information.

CROSS REFERENCE TO THE RELATED APPLICATION

This application claims the benefit of Japanese Patent Application No. 2020-043699, filed on Mar. 13, 2020, which is hereby incorporated by reference herein in its entirety.

### BACKGROUND

### Technical Field

The present disclosure relates to techniques for customizing the settings of equipment installed in a vehicle.

### Description of the Related Art

Patent Document 1 discloses a technique relating to a vehicle interior environment information sharing system.

According to the system disclosed in Patent Document 1, based on a value set by user in one vehicle of several vehicles, a vehicle environment estimating unit estimates the vehicle environment information desired by a user.

A memory or storage unit stores the in-vehicle environment information estimated by the in-vehicle environment estimation unit in association with the user.

Further, a customization information converter converts the in-vehicle environment information stored in the storage unit so as to be compatible with another vehicle of the several vehicles.

### PRIOR ART DOCUMENTS

### [Patent Document]

### [8 Patent Document 1]

JP-A-2012-218454

### SUMMARY

It is an object of the present disclosure to provide a technique capable of more suitably customizing various settings in equipment mounted on a vehicle.

A system according to first aspect of the present disclosure comprises a user terminal for each user, and an in-vehicle device mounted on a vehicle, wherein

each user terminal stores the user's personalization information for the equipment of the vehicle;

the in-vehicle device:

receives the personalization information from one or more user terminals present in a predetermined range from the vehicle;

stores the received personalization information in a storage unit;

performs an authentication process to identify a specific user on board the vehicle;

selects the personalization information corresponding to the identified specific user from the personalization information stored in the storage; and

transmits the selected personalization information to an equipment controller controlling each equipment of the vehicle.

An in-vehicle device according to a second aspect of the present disclosure is mounted on a vehicle and comprises a controller, wherein

the controller configured to execute:

receiving personalization information of each user for the equipment of the vehicle from one or more user terminals present in a predetermined range from the vehicle,

storing the received personalization information in a storage unit;

performing an authentication process to identify a specific user on board the vehicle;

selecting the personalization information corresponding to the identified specific user from the personalization information stored in the storage unit and

transmitting the selected personalization information to an equipment controller controlling the equipment of the vehicle.

An information processing method according to a third aspect of the present disclosure, is executed by a computer in a system comprising: a user terminal for each user; and an in-vehicle device mounted on a vehicle, wherein

the user terminal of each user stores personalization information of each user for the equipment of the vehicle, and

the information processing method includes:

receiving, by the in-vehicle device, the personalization information from one or more user terminals present within a predetermined range from the vehicle;

storing the received personalization information in a storage;

performing an authentication process to identify a specific user on board the vehicle;

selecting the personalization information corresponding to the identified specific user from the personalization information stored in the storage; and

transmitting the selected personalization information to an equipment controller controlling the equipment of the vehicle.

According to the present disclosure, it is possible to more suitably customize various settings of the equipment mounted on the vehicle.

### BRIEF DESCRIPTION OF THE DRAWINGS

FIG. 1 is a diagram showing a schematic configuration of information management system according to an embodiment.

FIG. 2 is a diagram showing a schematic configuration of the in-vehicle device and the ECU in vehicle.

FIG. 3 is a diagram showing specific examples of several equipment and setting items to be customized by personalization information.

FIG. 4 is a block diagram schematically showing an exemplary functional configuration of a user terminal, in-vehicle device, and management server.

FIG. 5 is a sequential diagram showing the flow of information processing in the information management system.

FIG. 6 is a diagram illustrating an example of a table configuration of personalization information DB.

FIG. 7 is a sequence diagram showing the flow of information processing in the information management system.

### DESCRIPTION OF THE EMBODIMENTS

A system according to a first aspect of the present disclosure includes: a user terminal; and an in-vehicle device.

The user terminal is a terminal operated by a user using this system.

In addition, the in-vehicle device is a device mounted on for example a third-party vehicle on which the user using this system rides.

The user terminal contains personalization information of the user that owns and/or operates the user terminal.

Personalization information is information for performing various settings for the equipment included in vehicle.

In other words, when a user rides on a vehicle, the personalization information is information for customizing various settings of the equipment provided in, for example, a third-party vehicle to the settings corresponding to the particular user on board the vehicle.

In the system according to the first aspect of the present disclosure, the in-vehicle device receives personalization information stored in each terminal from one or more user terminal(s) existing within a predetermined range from the vehicle.

The in-vehicle device receives personalization information not only from the user terminal owned and/or operated by that user who actually gets-in to the vehicle, but also from the user terminal(s) owned and/operated by other users around the vehicle.

The in-vehicle device receives personalization information from the user terminal owned and/or operated by that user who actually gets-in the vehicle when the user is within a predetermined range from the vehicle.

The in-vehicle device receives personalization information from the user terminal owned and/or operated by that user actually getting-in the vehicle at a point in time prior to the user actually getting-in the vehicle.

The predetermined range at which the in-vehicle devices receives the personalization information from the user actually getting-in the vehicle may be a range, for example, in which direct communication can be reliably performed between the in-vehicle device and the user terminal.

The in-vehicle device also stores personalization information received from one or more user terminals in a storage or memory unit.

As a result, not only is personalization information about that user actually getting-in the vehicle is stored, but also personalization information about other user(s) not actually getting-in the vehicle are temporarily stored in the storage or memory unit.

The in-vehicle device performs an authentication process.

The authentication process is a process for specifying a specific user, which is the user actually riding in the vehicle.

This authentication process is performed with a specific user riding in the vehicle.

By performing this authentication process, the in-vehicle device can grasp the specific user that actually boarded the vehicle.

The in-vehicle device then selects personalization information corresponding to the specific user identified by the authentication process from other personalization information stored in the storage or memory unit.

In addition, the in-vehicle device transmits personalization information of the selected specific user to the equipment controller which controls the respective equipment provided in the vehicle according to the transmitted personalization information.

The vehicle's equipment is the target of customization of the personalization information. The equipment controller customizes the settings corresponding to the specific user's personalization information when the equipment controller receives the personalization information of the specific user.

As described above, according to the system of the first aspect of the present disclosure, personalization information of a specific user is stored in storage at a point in time prior to specific user actually getting-in the vehicle.

Thereafter, when the specific user rides in the vehicle, personalization information of the specific user stored in storage is transmitted to the equipment controller.

Based on personalization information of the specific user, customization of various settings in the equipment mounted on vehicle is executed.

Thus, the customization of, for example, a third-party vehicle based on the user's personalization information can be completed earlier than if the user's personalization information is transmitted to the vehicle after the specific user boards the vehicle.

Hereinafter, specific embodiments of the present disclosure will be described with reference to the drawings.

The dimensions, materials, shapes, relative arrangements, and the like of the constituent parts described in the present embodiments are not intended to limit the technical scope of the invention to only those dimensions, materials, shapes, and the like unless otherwise specified.

### FIRST EMBODIMENT

Various settings in the equipment installed in the vehicle can be customized according to user that is to be driver of the vehicle.

On the other hand, a single vehicle may be used by more than one user, such as a ride-share vehicle or a rental car.

In such cases, it is desired to customize various settings in the vehicle equipment for each user using the vehicle.

Here, an embodiment in which a system, an in-vehicle device, and an information processing method according to the present disclosure are applied to a system for customizing various settings in a vehicle's equipment used by the several users according to the present disclosure will be described.

### (Outline of System)

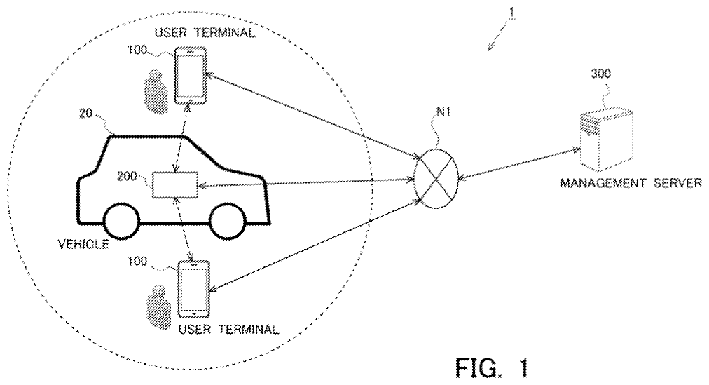

FIG. 1 is a diagram showing a schematic configuration of the information management system according to the present embodiment.

The information management system 1 is a system for managing personalization information for customizing a vehicle.

The information management system 1 includes a user terminal 100 owned and/or operated by each of several users, an in-vehicle device 200 mounted on or in the vehicle 20, and a management server 3(X).

According to the in the information management system 1, when a user rides on a vehicle 20, various settings in the equipment provided in the vehicle 20 are customized to the settings corresponding to that specific user based on the user's personalization information.

According to the in the information management system 1, the user terminal 100 and the in-vehicle device 200 are connected to the management server 300 by network N1.

The network N1 may be, for example, a worldwide public communication network such as a Wide Area Network or a telephone communication network such as a mobile telephone network.

In addition, short-range wireless communication is performed between the user terminal 100 and the in-vehicle device 200.

The user terminal 100 includes, for example, a computer having a processor, a primary storage, an auxiliary storage, a communication interface (communication I/F), a short-range communication interface (short-range communication I/F), and an input/output interface (input/output I/F).

The user terminal 100 may be a smart phone, a tablet computer, a mobile computer, or a wearable computer.

In addition, user terminal 100 executes a predetermined application for using information management system 1.

First information is stored in user terminal 100.

The first information is a part of personalization information of the user who owns and/or operates user terminal 100.

The first information will be described in detail later.

The management server 300 is configured to include, for example, a conventional computer.

The computer comprising management server 300 has, for example, a processor, a primary storage, an auxiliary storage, and a communication interface (communication I/F).

Second information of each user that uses information management system 1 is stored in management server 300.

The second information is information other than the first information of each user's personalization information.

That is, management server 300 contains second information for more than one user.

The second information will be described in detail later.

The in-vehicle device 200 is a device that transmits personalization information of a specific user, which is a user riding on vehicle 20, to an ECU (Electronic Control Unit).

The ECU controls the respective equipment provided by vehicle 20.

Here, in-vehicle device 200 receives the first information of personalization information of the specific user from user terminal 100 owned and/or operated by specific user.

The in-vehicle device 200 receives the second information of personalization information of specific user from the management server 300.

The in-vehicle device 200 transmits the first information received from user terminal 100 and the second information received from the management server 300 to the ECU in vehicle 20.

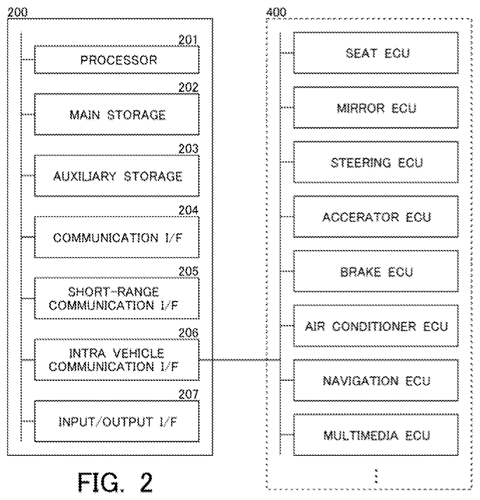

FIG. 2 is a diagram showing a schematic configuration of in-vehicle device 200 and the ECU in vehicle 20 according to an exemplary embodiment. The in-vehicle device 200 includes a computer that can be mounted on vehicle 20.

The computer configuring in-vehicle device 200 includes a processor 201, a main storage 202, an auxiliary storage 203, a communication interface (communication I/F) 204, a short-range communication interface (short-range communication I/F) 205, an intra vehicle communication interface (intra vehicle communication I/F) 206, and an input/output interface (input/output I/F) 207.

Here, processor 201 is, for example, a CPU (Central Processing Unit) or a DSP (Digital Signal Processor).

Main storage 202 is, for example, RAM (Random Access Memory).

The auxiliary storage 203 may be, for example, a ROM (Read Only Memory), an HDD (Hard Disk Drive), or a flash memory.

The ancillary storage 203 may also include a removable medium (portable recording medium). Here, the removable media is, for example, a USB memory, an SD card, or a disc recording medium such as a CD-ROM, a DVD disc, or a Blu-ray disc.

The communication I/F 204 is an interface for connecting in-vehicle device 200 to network N1.

The communication I/F 204 connects in-vehicle device 200 to network N1 using a predetermined wireless communication standard such as 3G (3rd Generation or Long Term Evolution.

The communication I/F 204 includes, for example, wireless communication circuitry for a LAN (Local Area Network) interface board or wireless communication.

The short-range communication I/F 205 is an interface for in-vehicle device 200 to perform direct communication with user terminal 100 using a predetermined short-range wireless communication standard.

As the predetermined short-range wireless communication standard, Bluetooth (registered trademark) LowEnergy standard, WiFi (registered trademark), or the like can be exemplified.

Intra vehicle communication I/F 206 is an interface for in-vehicle device 200 to communicate with other devices provided in vehicle 20 using the predetermined intra-communication standard.

As the predetermined intra-communication standard, CAN (Controller Area Network), LIN (Local Interconnect Network), or the like can be exemplified.

Then, in-vehicle device 200 is connected to the vehicle's ECU via intra vehicle communication I/F 206 in vehicle.

The ECU that communicates with in-vehicle device 200 via intra vehicle communication I/F 206 is an ECU that controls equipment to be customized by personalization information. As shown in FIG. 2, such an ECU can be exemplified as seat ECU, mirror ECU, steering ECU, accelerator ECU, brake ECU, air conditioner ECU, navigation ECU, and multimedia ECU.

Here, the seat ECU is an ECU that controls the seat in the vehicle cabin.

The mirror ECU is an ECU for controlling the side mirror and the rearview mirror.

The steering ECU is an ECU that controls the steering wheel.

The accelerator ECU is an ECU that controls the accelerator pedal.

The brake ECU is an ECU that controls the brake pedal.

The air conditioner ECU is an ECU that controls the air conditioner.

The navigation ECU is an ECU that controls the navigation device.

A multimedia ECU is an ECU that controls a multimedia player.

In the following, the ECU that controls equipment subject to customization by personalization information is collectively referred to as “equipment ECU” 400.

In the present embodiment, equipment ECU 400 corresponds to for example the “equipment controller” disclosed herein.

The input/output I/F 207 is an interface used for information input by user in the vehicle and information output to user in the vehicle.

The input/output I/F 207 includes, for example, a touch panel display.

In in-vehicle device 200 configured as described above, the operating system (OS), various programs, various information tables, and the like are stored in the auxiliary storage 203. Processor 201 loads the program stored in the auxiliary storage 203 into the main storage 202 and executes the program, thereby realizing a process for customizing vehicle 20, which will be described later.

However, some or all of the functions in the in-vehicle device 200 may be implemented by hardware circuitry such as ASIC and/or FPGA.

In-vehicle device 200 does not necessarily have to be realized by a single physical configuration, and may be configured by more than a single computer cooperating with each other.

### (Personalization Information)

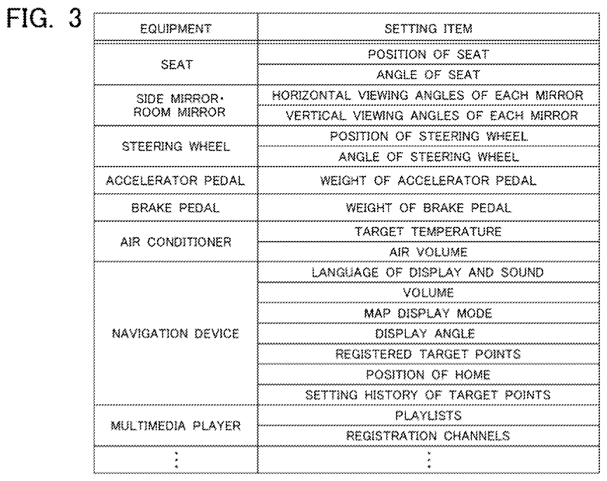

A specific embodiment of personalization information for customizing vehicle 20 will now be described with reference to FIG. 3.

FIG. 3 is a diagram showing specific examples of several equipment and setting items to be customized by personalization information.

As shown in FIG. 3, equipment subject to customization can be exemplified as seats in the cabin, side mirrors and room or rear-view mirrors, steering wheels, accelerator pedals, brake pedals, air conditioners, navigation devices, and multimedia players.

These equipment are controlled by equipment ECU 400 shown in FIG. 2.

Then, for the seat in the vehicle interior, the position and angle of the seat can be exemplified as setting items.

For side and room or rear-view mirrors, the horizontal and vertical viewing angles of each mirror can be exemplified as setting items.

For steering wheels, the position and angle of the steering wheel can be exemplified as setting items.

As for the accelerator pedal, the weight of the accelerator pedal can be exemplified as a setting item.

For brake pedals, the weight of the brake pedal can be exemplified as a setting item.

As for the air conditioner, the target temperature and the air volume can be exemplified as setting items.

For the navigation device, the language of the display and sound, volume level, map display mode, display angle, registered target points, position of home, and setting history of the target points can be exemplified as setting items.

For multimedia players, playlists and registration channels may be exemplified as setting items.

The personalization information of each user contains the per user settings for the individual equipment settings that the user wants to customize.

In the vehicle 20, the setting items of each equipment are controlled by equipment ECU 400 on the basis of the personalization information of the specific user riding in the vehicle 20. This customizes the various settings in the vehicle equipment to reflect the settings contained in the personalization information of a specific user.

In the information management system 1, as described above, personalization information of each user is divided into first information and second information.

That is, setting values of some items among the several setting items in the various vehicle equipment are allocated to the first information.

The setting values of other items among the setting items in the various vehicle equipment are distributed to the second information.

At this time, the items included in the first information and the items included in the second information are determined in advance.

In the personalization information, information to be treated as the first information and information to be treated as the second information are also determined in advance.

In particular, the first information is defined as information for the setting items for which it is desired to complete the customization relatively earlier when user enters vehicle 20.

However, in the personalization information for a user, the first information and the second information are defined such that the total data capacity of the second information is larger than the total data capacity of the first information.

In the information management system 1, the first information of each user is stored in the user terminal 100 owned and/or operated by the respective user.

The second information of each user is stored in the management server 300.

Then, in information management system 1, the in-vehicle device 200 receives the first information stored in each of the user terminal(s) 100 within a predetermined range from vehicle 20 by the short-range wireless communication.

Here, the predetermined range is, for example, a range capable of performing a short-range wireless communication between in-vehicle device 200 and user terminal 100.

Incidentally, in FIG. 1, the range shown surrounded by a broken line shows a predetermined range.

In other words, the in-vehicle device 200 receives the first information not only from user terminal 100 owned and/or operated by the user who actually boards vehicle 20, but also from user terminal 100 owned and/or operated by another user that is present around the vehicle 20, i.e., also within the predetermine range.

The in-vehicle device 200 receives the first information from user terminal 100 owned and/or operated by the user who actually boards vehicle 20 at a point of time prior to the user riding in vehicle 20.

The in-vehicle device 200 also stores the first information received from one or more other user terminals 100 not actually riding in vehicle 20, but within the predetermine range in a personalization information database described later.

The in-vehicle device 200 performs an authentication process.

The authentication process is a process for specifying that specific user, which is the user actually riding in vehicle 20.

The in-vehicle device 200 then selects the first information corresponding to that specific user identified by the authentication process among the various different first information stored in the personalization information data base.

The in-vehicle device 200 then transmits the selected first information to equipment ECU 400.

As a result, equipment ECU 400 customizes the target equipment based on the transmitted first information from in-vehicle 200.

The in-vehicle device 200 then receives second information corresponding to the specific user from the management server 300.

Further, in-vehicle device 200 transmits the received second information to equipment ECU400.

As a result, equipment ECU400 customizes the target equipment based on the first and the second information.

### (Function Configuration)

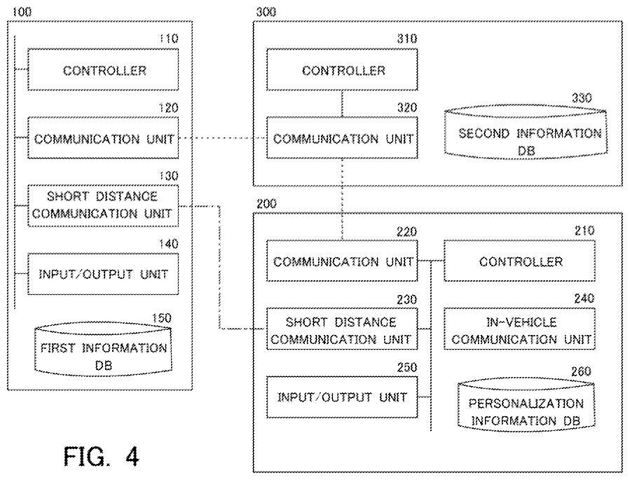

Next, a functional configuration of each of user terminal 100, in-vehicle device 200, and management server 300 constituting information 1 according to the present embodiment will be described with reference to FIG. 4.

FIG. 4 is a block diagram schematically showing an exemplary functional configuration of each of user terminal 100, in-vehicle device 200, and management server 300.

### (User Terminal)

The user terminal 100 includes a controller 110, a communication unit 120, a short distance communication unit 130, an input/output unit 140, and a first information data base 150.

The first information data base 150 is referred to as the first information DB 150.

The controller or control unit 110 includes a function of performing arithmetic processing for controlling the user terminal 100.

The control unit 110 may be implemented by the processor.

Communication unit 120 has a function of connecting user terminal 100 to network N1.

Communication unit 120 includes a communication I/F.

Communication unit 120 can communicate with management server 300 via network N1 by using mobile communication services.

Controller 110 transmits user ID for identifying a specific user on vehicle 20 to management server 300 via communication unit 120, as will be described later.

Short distance communication unit 130 has a function to communicate with in-vehicle device 200 when user terminal 100 is within a predetermined range from vehicle 20.

Short distance communication unit 130 includes a short-range communication I/F.

The short-range communication I/F included in short distance communication unit 130 is an interface that performs communication using the same short-range wireless communication standard as that of the short-range communication I/F 205 in the in-vehicle device 200 described above.

When user terminal 100 is within a predetermined range from vehicle 20, controller 110 transmits the first information of the user having user terminal 100 to the in-vehicle device 200 via short distance communication unit 130.

At this time, controller 110 transmits the user ID and the PIN (Personal Identification Number) code together with the first information to the in-vehicle device 200.

The user ID is an ID for identifying a user having user terminal 100.

A PIN code is the code associated with the user terminal 100.

In the user terminal 100, the first information of the user having user terminal 100 is stored in advance in the first information DB 150.

The first information DB 150 is included in the ancillary storage of the user terminal 100.

The input/output unit 140 has a function of accepting information inputs and a function of outputting information.

Input/output unit 140 includes input and output I/Fs such as cameras and touch panel display.

The controller 110 performs a process of inputting or outputting required information via input/output unit 140 when an authentication process described later is performed.

### (In-Vehicle Device)

The in-vehicle device 200 includes a controller 210, a communication unit 220, a short distance communication unit 230, an in-vehicle communication unit 240, an input/output unit 250, and a personalization information database (personalization information database) 260.

Controller 210 has a function of performing arithmetic processing for controlling the in-vehicle device 200.

Controller 210 also has a function of performing an authentication process for specifying a specific user.

Controller 210 may be implemented by the processor 201.

Communication unit 220 has a function of connecting the in-vehicle device 200 to network N1.

Communication unit 120 includes a communication I/F 204.

Communication unit 220 can communicate with management server 300 via network N1.

Controller 210 receives the second information of a specific user on the vehicle 20 from the management server 300 via communication unit 220.

Short distance communication unit 230 has a function of communicating with a user terminal 100 when the user terminal 100 is within a predetermined range from vehicle 20.

Short distance communication unit 230 is configured to include a short-range communication I/F 205.

Controller 210 receives from user terminal 100 the first information of the user holding the user terminal 100, user ID for identifying the user, and PIN code associated with the user terminal when the user terminal 100 is within a predetermined range from vehicle 20.

Controller 210 stores the first information, user ID, and PIN code received from user terminal 100 in personalization information DB 260 in association with each other.

Controller 210 stores the second information of specific user received from management server 300 in the personalization information database 260.

As a result, the first information received from each user terminal 100 and the second information received from the management server 300 are stored in personalization information database 260.

Controller 210 stores the second information of the specific user in personalization information DB 260 in association with the IDs of the specific user.

As a result, in personalization information database 260, the first information and the second information of the specific user, the user ID of the specific user, and the PIN code of user terminal 100 owned and/operated by the specific user are stored in association with each other.

Personalization information database 260 can be implemented in the auxiliary storage 203 by executing the database management system (Database Management System) program by processor 201.

The in-vehicle communication unit 240 has a function to communicate with equipment ECU 400 within vehicle 20.

The in-vehicle communication unit 240 is configured to include intra vehicle communication I/F 206.

Here, when controller 210 identifies the specific user by the authentication process, the first information corresponding to the specific user is selected among the first information stored in personalization information DB 260.

Controller 210 transmits the selected first information, i.e., the first information of the specific user, to equipment ECU 400 via the in-vehicle communication unit 240 in the vehicle.

Controller 210 transmits the second information of the specific user received from management server 300 to equipment ECU 400 via the in-vehicle communication unit 240.

Input/output unit 250 has a function of accepting information inputs and a function of outputting information.

Input/output unit 250 includes an input/output I/F 207.

Controller 210 performs a process of inputting or outputting a required information via input/output unit 250 when the authentication process described later is performed.

### (Management Server)

Management server 300 includes a controller 310, a communication unit 320, and a second information data base 330.

The second information data base 330 is referred to as the second information DB 350.

The control unit 310 includes a function of performing arithmetic processing for controlling the management server 300.

The control unit 310 may be implemented by the processor.

Communication unit 320 has a function of connecting management server 300 to network N1.

Communication unit 320 includes a communication I/F.

Communication unit 320 can communicate with user terminal 100 and in-vehicle device 200 via network N1.

As will be described later, controller 310 receives user IDs for identifying the specific user on vehicle 20 from in-vehicle device 200 via communication unit 320.

In the second information DB330, the second user ID is stored in advance with the second information associated with user ID of the specific user.

When controller 310 receives the specific user ID from in-vehicle device 200, it selects the second information corresponding to specific user's ID from the second information DB330.

Furthermore, controller 310 performs a process of transmitting the selected second information to in-vehicle device 200 via communication unit 320.

The second information DB 330 may be implemented in the supplemental storage of management server 300.

### <Information Processing Flow>

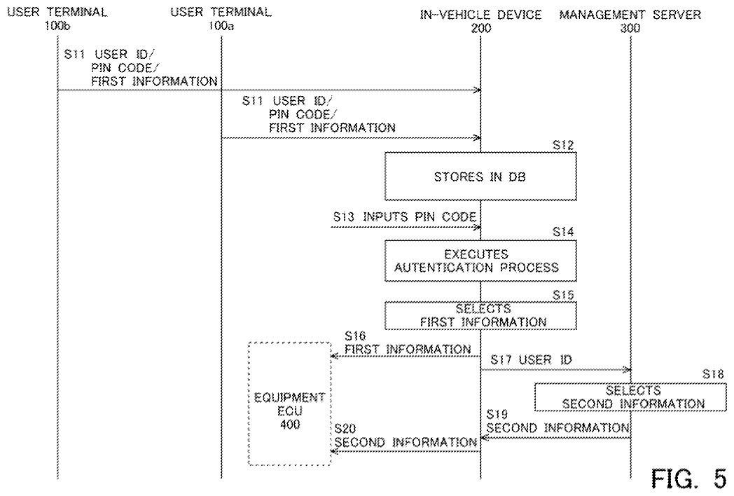

Hereinafter, the flow of information processing in information management system 1 will be described with reference to FIG. 5.

FIG. 5 is a sequential diagram showing the flow of information processing in information management system 1.

Note that, in FIG. 5, two user terminal's 100 existing within a predetermined area from vehicle 20 are represented by user terminal 100a and user terminal 100b.

In the present embodiment, in-vehicle device 200 receives the first information, user ID, and PIN code from the respective user terminals 100 (100a, 100b) existing within a predetermined range from vehicle 20 by the short-range wireless communication (S11).

In-vehicle device 200 stores the first information, user ID, and PIN code received from the respective user terminals 100 in personalization information DB 260 (S12).

At the time when the process of S12 is executed, the user serving as the specific user has not yet boarded the vehicle 20.

Also stored in personalization information DB 260 is the first information of other users which exist around vehicle 20 but does not actually board the vehicle 20.

When the specific user rides in vehicle 20, the specific user inputs the PIN code of the user terminal 100 owned and/or operated by the specific user to the input/output I/F 207 of the in-vehicle device 200 (S13).

At this time, PIN code may be displayed on the input/output I/F of the specific user's terminal device 100.

In this instance, the specific user may refer to the PIN code displayed on the specific user's terminal 100 and input the PIN code to the input/output I/F 207 of the in-vehicle device 200. In addition, the specific user may cause the input/output I/F 207 of the in-vehicle device 200 to read the PIN code displayed on specific user's terminal 100.

When PIN code is input to the input/output I/F 207 by the specific user, in-vehicle device 200 executes the authentication process for specifying specific user (S14).

This authentication process is based on the PIN code entered by specific user.

More specifically, it is determined that the user associated with the same PIN code as the PIN code input to the input/output I/F 207 among the users in which the first information is stored in personalization information DB 260 is the specific user.

In step S15, in-vehicle device 200 selects the first information of specific user specified by the authentication process among the first information stored in personalization information DB 260.

That is, the first information associated with the same PIN code as the PIN code entered in the input/output I/F 207 is selected as the first information of the specific user.

Further, in-vehicle device 200 transmits the selected first information (first information of specific user) to the ECU400 (S16).

Note that in the in-vehicle device 200, when, by the authentication process, the specific user is identified, information (first information, user ID, and PIN code) corresponding to the user(s) other than the specific user is deleted from the personalization information DB 260.

The process of deleting information corresponding to a user or user(s) other than the specific user from the personalization information DB 260 is executed by controller 210.

As a result, unnecessary information is prevented from being stored in personalization information DB 260.

When the specific user who is actually ride in the vehicle is specified by the authentication process, the in-vehicle device 200 transmits user ID of the specific user stored in personalization information DB 260 to management server 300 via network N1 (S17).

The specific user's ID is the user ID associated with the same PIN code as the PIN code entered in the input/output I/F 207.

In management server 300, when the specific user's ID is received, the second information corresponding to the specific user's ID is selected from the second information stored in the second information DB 330 (S18).

That is, the second information associated with the same user ID as the user ID received from the in-vehicle device 200 is selected as the second information of the specific user. Further, management server 300 transmits the selected second information (second information of the specific user) to the in-vehicle device 200 via network N1 (519).

In step S20, in-vehicle device 200 transmits the second information of the specific user received from management server 300 to equipment ECU 400.

(Effects of this System)

As described above, personalization information of each user is used for customizing vehicle 20, and this information is divided into the first information and the second information.

Then, the first information has been stored in user terminal 100.

As noted above, the first information is information for items in which it is desired that the customization be completed relatively earlier relative to when the user boards vehicle 20.

Then, when user boards vehicle 20, the first information is transmitted from user terminal 100 to in-vehicle device 200 by the short-range wireless communication.

On the other hand, the second information is transmitted from management server 300 to in-vehicle device 200 via network N1.

According to this, when the user boards vehicle 20, the first information is transmitted to in-vehicle device 200 more quickly as compared to the second information.

Therefore, the first information can be transmitted to the in-vehicle device 200 more quickly as compared to if the first information was transmitted from the management server 300 to in-vehicle device 200 via network N1, as in the case for the second information.

Therefore, the customization of the target equipment based on the first information in vehicle 20 can be completed relatively early in the customization process.

That is, according to information management system 1, the customization of the target equipment based on some of the personalization information (first information) can be completed earlier than when all of the personalization information can be completed, including transmission of both the first information and the second information from management server 300 to the in-vehicle device 200.

On the other hand, if not only the first information but also the second information is to be transmitted from the user terminal 100 to the in-vehicle device 200 by the short distance wireless communication via the short distance wireless communication, then the second information needs to be stored in the user terminal in addition to the first information.

In such a situation, the user terminal 100 would require a very large amount of storage to store the personalization information, i.e., to store both the first and second information.

For these reasons, it is desirable in the information management system 1, for the personalization information transmitted from the user terminal 100 to the in-vehicle device 200 include only the first information.

The second information is then transmitted from management server 300 to in-vehicle device 200.

Thus, in user terminal 100, it is possible to minimize the storage capacity required to store personalization information.

Further, as described above, for purposes of the personalization information of one user, the total data capacity of the second information is somewhat larger than the total data capacity of the first information.

By reducing the total amount of data in the first information, it is possible to further minimize the storage capacity required only to store the first information in user terminal 100.

Further, as described above, the in-vehicle device 200 receives the first information stored in each user terminal 100 from one or more user terminal's 100 present within a predetermined area from vehicle 20.

According to this operation, the first information of the specific user is stored in the personalization information DB 260 at a point in time prior to the specific user actually getting in the vehicle 20.

When the specific user gets in vehicle 20, the first information of the specific user stored in personalization information DB 260 is transmitted to equipment ECU 400.

As a result, customization of various settings in equipment mounted on the vehicle 20 is executed on the basis of the first information of the specific user.

Therefore, the first information can be supplied to the ECU 400 earlier than when the first information of specific user is transmitted to vehicle 20 after specific user rides in vehicle 20.

As a result, the customization of vehicle 20 based on the first information can be completed earlier.

In the present embodiment, the authentication process for specifying the specific user who is riding in the vehicle is performed based on the PIN code inputted to in-vehicle device 200 by the specific user.

The first information corresponding to specific user specified by authentication process is selected from the first information stored the in personalization information DB 260.

The selected first information is transmitted to ECU400.

This authentication process allows the ECU 400 to transmit the first authentication process corresponding to the specific user even if information for identifying user terminal 100 owned and/or operated by a user serving as the specific user has not previously registered in the in-vehicle device 200. This allows the in-vehicle device 200 to know the specific user.

The input code inputted to the in-vehicle device 200 for use in the authentication process is not necessarily limited to a PIN code.

That is, the input code inputted to the in-vehicle device 200 may be a code which is transmitted from the user terminal 100 to the in-vehicle device 200 together with the first information and which is linked to the user ID.

### EXAMPLE MODIFICATION 1

In the information management system 1, the user terminal 100 may transmit the encrypted first information to the in-vehicle device 200.

The In-vehicle device 200 stores the encrypted first information in the personalization information DB260.

In the in-vehicle device 200, when the specific user is specified by the authentication process, controller 210 selects the first information of the specific user among the first information stored in the personalization information DB 260.

Controller 210 then decodes the selected first information.

Controller 210 transmits the decoded first information of the specific user to ECU400.

In this instance, controller 210 deletes the first information of user(s) other than the specific user, which is stored in personalization information DB260 in an encrypted form, from personalization information DB without first decrypting it.

Thus, by transmitting the first information encrypted from the user terminal 100, the security of the first information can be improved.

### EXAMPLE MODIFICATION 2

As described above, in the information management system 1, information corresponding to a user other than the specific user once stored in personalization information DB260 of in-vehicle device 200 is deleted from the personalization information DB260 when the specific user actually riding in the vehicle is identified by authentication process.

On the other hand, information corresponding to user that has become the specific user may be continuously stored in personalization information DB 260.

Here, after one user uses vehicle 20 as the specific user, another user may use the same vehicle 20 as the specific user.

In this instance, the in-vehicle device 200 stores personalization information corresponding to each of several users in the personalization information DB 260.

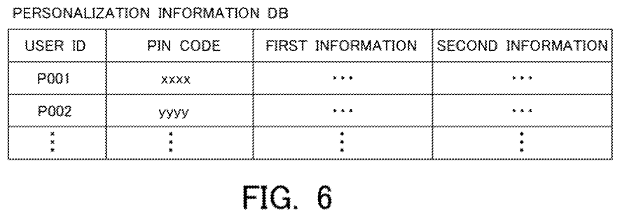

FIG. 6 is a diagram illustrating an example of a table configuration of personalization information DB260 in which user ID, PIN code, first information, and second information resulting in the specific user are stored.

PIN code is the PIN code of user terminal 100 owned and/or operated by the user.

As shown in FIG. 6, in the personalization information DB 260, user ID, PIN code, the first information, and the second information, which correspond to each user on vehicle 20 as a specific user, are stored in association with each other.

The upper or maximum limit of the number of users that can continuously store information in personalization information DB 260 may be set in advance.

A user corresponding to the user ID stored in personalization information DB 260 is a user that has ridden on the vehicle 20 as a specific user.

When such a user rides the vehicle 20 again, the first information and the second information of the user stored in the personalization information DB 260 are transmitted from in-vehicle device 200 to ECU400.

At this time, when the specific user is specified by the authentication process in the in-vehicle device 200, controller 210 determines whether or not information relating to the specific user is stored in the personalization information DB 260.

This determination is made based on whether or not the same user ID as the user ID of the current specific user is stored in the personalization information DB 260.

This determination may be performed based on the PIN code.

When it is determined that information of the current specific user is stored in the personalization information DB260, controller 210 transmits the first and second information stored in the personalization information DB260 associated with user ID (or PIN code) of the specific user to ECU400.

In this instance, the communication between in-vehicle device 200 and management server 300 after the authentication process is executed is not performed, that is, the processes of S17, S18, and S19 shown in FIG. 5 are not performed.

According to the above, when a user who has previously boarded vehicle 20 as a specific user boards vehicle 20 again, it can be supplied from the in-vehicle device 200 to ECU400 without receiving the user's second information from management server 300.

Therefore, in such a situation, not only the customization of vehicle 20 based on the first information but also the customization of vehicle 20 based on the second information can be completed earlier.

### SECOND EMBODIMENT

The schematic configuration of the information device management system according to the present embodiment is the same as that of the first embodiment described above.

However, in the present embodiment, the content of the authentication process for specifying the specific user executed in the in-vehicle device 200 differs from that of the first embodiment.

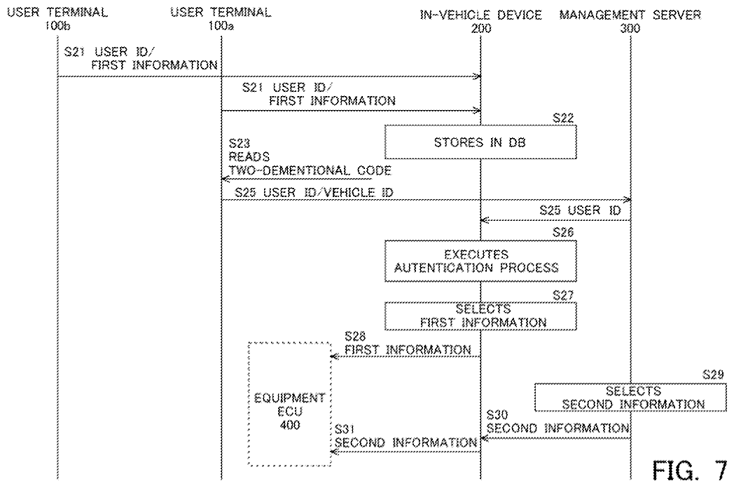

Hereinafter, the flow of information processing in the information management system 1 will be described with reference to FIG. 7.

FIG. 7 is a sequence diagram showing the flow of information processing in the information management system.

Also in FIG. 7, as in FIG. 5, two user terminal's 100 present within predetermined ranges from vehicle 20 are represented by user terminal 100a and user terminal 100b.

In FIG. 7, user terminal 100a is user terminal 100 owned and/or by a user serving as the specific user.

In this embodiment, the in-vehicle device 200 receives the first information and user ID from the respective user terminals 100 (100a, 100b) existing within a predetermined range from vehicle 20 by the short-range wireless communication (S21).

The in-vehicle device 200 stores the first information and the user ID received from user terminals 100 in the personalization information DB260 (S22).

Similar to the first embodiment, when the process of S22 is executed, the user serving as specific user has not yet boarded the vehicle 20.

Also stored in the personalization information DB 260 is the first information of another user which exists around vehicle 20, i.e., within the predetermine range but this other user does not actually ride in the vehicle 20.

When the specific user gets in the vehicle 20, a two-dimensional code (e.g., QR code (registered trademark)) including a vehicle ID for identifying vehicle 20 is displayed on the input/output I/F 207 of the in-vehicle device 200.

When the two-dimensional code is displayed on the input/output I/F 207, the two-dimensional code is read by the input/output I/F of user terminal 100a owned and/or operated by the specific user riding in vehicle 20 (S23).

As a result, user terminal 100a owned and/or operated by the specific user acquires the vehicle ID.

The process of displaying two-dimensional codes on the input/output I/F 207 of the in-vehicle device 200 is executed by controller 210.

The indication code displayed on the input/output I/F 207 is not necessarily limited to two-dimensional codes.

That is, the indication code displayed in the input/output I/F 207 can be any code that contains the vehicle ID and can be read by the user terminal 100.

When acquiring the vehicle ID, the user terminal 100a owned and/or operated by the specific user transmits the user ID (user ID of specific user) and the vehicle ID to the management server 300 via network N1 (S24).

Upon receiving the user ID and vehicle ID from the user terminal 100a, management server 300 identifies vehicle 20 on which specific user rides based on the vehicle ID.

In step S25, management server 300 transmits the user ID received from the user terminal 100a to the in-vehicle device 200 provided in the specified vehicle 20 via network NI.

When the in-vehicle device 200 receives the user ID transmitted from management server 300, the authentication process for specifying the specific user is executed in the in-vehicle device 200 (S26).

This authentication process is based on the user IDs received from the management server 300.

More specifically, it is determined that the user corresponding to the same user ID as the user ID received from management server 300 among the several users having the first information stored in the personalization information DB 260 is the specific user who actually will ride in the vehicle.

In step S27, in-vehicle device 200 selects the specific user's first information specified by the authentication process from the first information stored in the personalization information DB 260.

That is, the first information associated with the same user ID as the user ID received from management server 300 is selected as the first information of the specific user.

Further, the in-vehicle device 200 transmits the selected first information (first information of the specific user) to ECU400 (S27).

As in the first embodiment, in the in-vehicle device 200, when, by the authentication process, the specific user is identified, information (the first information and the user ID) corresponding to user(s) other than the specific user and temporarily stored in the personalization information DB 260 is/are deleted from the personalization information DB260.

In the management server 300, the second information corresponding to the user ID of the specific user is selected from the second information stored in personalization information DB330 (S29).

That is, the second information associated with the same user ID as the user ID received from user terminal 100a is selected as the second information of the specific user.

Further, management server 300 transmits the selected second information (second information of the specific user) to the in-vehicle device 200 via network N1 (S30).

In step S31, the in-vehicle device 200 transmits the second information of the specific user received from the management server 300 to ECU400.

In the present embodiment, the user ID corresponds to the “user identification information” according to the present disclosure, and the vehicle ID corresponds to “vehicle identification information” according to the present disclosure.

Also in the present embodiment, the in-vehicle device 200 can identify the specific user without registering in advance any information for identifying the specific user's terminal 100 in the in-vehicle device 200.

Thus, the in-vehicle device 200 can transmit the first information corresponding to the specific user to ECU400.

Also in the present embodiment, effects by the information management system 1 can be obtained similarly to the first embodiment.

In addition, Modifications 1 and 2 of the first embodiment described above can also be applied to the second embodiment.

### (Other Embodiments)

One skilled in the art will understand that the above-described embodiments are examples, and the present disclosure can be implemented with changes made as appropriate without departing from the spirit of the present disclosure. For example, the processing and units described in the present disclosure can be implemented by being freely combined unless technical conflicts arise.

Moreover, the processing described as processing to be performed by a single apparatus may be performed by several apparatuses in a shared manner. Alternatively, the processing described as processing to be performed by different apparatuses may be performed by a single apparatus. As those skilled in the art will recognize, a computer system can be flexibly changed according to the hardware component (server component) used to implement each function.

The present disclosure can also be implemented by providing a computer program designed to implement the functions described in the above embodiments to a computer, and by one or more processors included in the computer for reading and executing the program. Such a computer program may be provided to the computer, for example, by using a non-transient computer-readable storage medium that can be connected to a system bus of the computer, or may be provided to the computer via a network. Examples of the non-transient computer-readable storage medium include any types of disks/discs such as magnetic disks (floppy(R) disk, hard disk drive (HDD), and the like) and optical discs (CD-ROM, DVD disc, Blu-ray Disc, and the like), read-only memory (ROM), random access memory (RAM), EPROM, EEPROM, magnetic card, flash memory, optical card, and any other type of media suitable for storing therein electronic instructions.

What is claimed is:

1. A system comprising:
a user terminal for each user; and
an in-vehicle device mounted on a vehicle, wherein each user terminal stores personalization information corresponding to the user of
the terminal for setting equipment of the vehicle;
the in-vehicle device:
receives the personalization information from at least one user terminal present within a predetermined range from the vehicle;
stores the received personalization information in a storage unit;
performs an authentication to identify a specific user on board the vehicle;
selects the personalization information corresponding to the identified specific user from the personalization information stored in the storage unit; and
transmits the selected personalization information to an equipment controller for controlling the equipment settings of the vehicle according to the received personalization information.

2. The system according to claim 1, wherein
the personalization information transmitted from the at least one user terminal to the in-vehicle device is encrypted, and
the in-vehicle device decrypts the personalization information corresponding to the specific user and transmits the decrypted personalization information to the equipment controller.

3. The system according to claim 1, wherein
the in-vehicle device deletes from the storage unit the personalization information corresponding to any user other than the specific user.

4. The system according to claim 1, wherein
the in-vehicle device receives the personalization information over a short-range wireless communication from the at least one user terminal.

5. The system according to claim 1, wherein
the in-vehicle device specifies, in the authentication, the specific user based on an input code entered by the specific user.

6. The system according to claim 5, wherein
the input code is a PIN code associated with the user terminal of the specific user.

7. The system according to claim 1, further comprising a server device, wherein
the user terminal of the specific user obtains vehicle identification information for identifying the vehicle from the in-vehicle device, and transmits the obtained vehicle identification information and user identification information for identifying the specific user to the server device,
the server device identifies the vehicle based on the vehicle identification information, and transmits the user identification information received from the user terminal to the in-vehicle device, and
the in-vehicle device identifies, in the authentication, the specific user based on the user identification information received from the server device.

8. The system according to claim 7, wherein
an indication code including the vehicle identification information is displayed on the in-vehicle device, and
the user terminal of the specific user obtains the vehicle identification information by reading the indication code.

9. The system according to claim 8, wherein
the indication code is a two-dimensional code.

10. An in-vehicle device mounted on a vehicle, comprising:
a controller configured for:
receiving personalization information from each user terminal present within a predetermined range from the vehicle, the personalization information providing settings of the vehicle,
storing the received personalization information in a storage unit
performing authentication to identify a specific user on board the vehicle;
selecting the personalization information corresponding to the identified specific user from the personalization information stored in the storage unit; and
transmitting the selected personalization information to an equipment controller for controlling equipment settings of the vehicle according to the selected personalization information.

11. The in-vehicle device according to claim 10, wherein
the personalization information transmitted from the at least one user terminal to the in-vehicle device is encrypted, and
the controller decrypts the personalization information corresponding to the specific user and transmits the decrypted personalization information to the equipment controller.

12. The in-vehicle device according to claim 10, wherein
the controller is further configured for deleting from storage the unit personalization information corresponding to any user other than the specific user.

13. The in-vehicle device according to claim 10, wherein
the controller receives the personalization information over a short-range wireless communication from the at least one user terminal.

14. The in-vehicle device according to claim 10, wherein the controller identifies the specific user based on an input code input by the specific user.

15. The in-vehicle device according to claim 10, wherein
the controller is further configured for receiving, via a server device, user identification information for identifying the specific user, the user identification information being transmitted from the user terminal of the specific user, and
the controller identifies the specific user based on the user identification information received from the server device, and
the server device receives vehicle identification information for identifying the vehicle and the user identification information for identifying the specific user from the user terminal of the specific user, identifies the vehicle based on the vehicle identification information, and transmits the user identification information to the in-vehicle device.

16. The in-vehicle device according to claim 15, wherein
the controller is further configured for displaying an indication code including the vehicle identification information, and
the user terminal of the specific user obtains the vehicle identification information by reading the indication code, and transmits the vehicle identification information to the server device.

17. An information processing method executed by a computer in a system comprising:
a user terminal for each user; and
an in-vehicle device mounted on a vehicle, wherein
the user terminal of each user stores personalization information of the user for providing equipment settings of the vehicle, and
the information processing method includes:
receiving, by the in-vehicle device, personalization information from at least one user terminal present within a predetermined range from the vehicle;
storing the received personalization information in a storage unit;
performing an authentication process to identify a specific user on board the vehicle;
selecting the personalization information corresponding to the identified specific user from the personalization information stored in the storage unit; and
transmitting the selected personalization information to an equipment controller for controlling equipment settings of the vehicle according to the selected personalization information.

18. The information processing method according to claim 17, wherein
the personalization information transmitted from the at least one user terminal to the in-vehicle device is encrypted, wherein
the information processing method includes:
decrypting the personalization information corresponding to the specific user, and transmitting the decrypted personalization information to the equipment controller.

19. The information processing method according to claim 17, further including deleting the personalization information corresponding to any user other than the specific user from the storage unit.

20. The information processing method according to claim 17, wherein the in-vehicle device receives the personalization information from the at least one user terminal over a short-range wireless communication.
